(19) United States
(12) Patent Application Publication
(10) Pub. No.: US 2004/0175152 A1
(43) Pub. Date: Sep. 9, 2004

(54) Method and apparatus of versatile audio video system

(76) Inventors: Haw-Renn Chen, Moorpark, CA (US); Feichu H. Chen, Moorpark, CA (US)

Correspondence Address: Haw-Renn Chen, 4057 Little Hollow Place, Moorpark, CA, 93021, US

(21) Appl. No.: 10/378,158

(22) Filed: Mar. 4, 2003

(51) Int. Cl. H04N 5/781

(52) U.S. Cl. 386/96; 386/125

(57) ABSTRACT

A method and apparatus of versatile audio video or karaoke system with configuration of one or more versatile connection means and versatile connection means frames such that any number or combination of audio video function units embedded with predetermined processing capabilities can be added to or removed from the upgradeable audio video or karaoke system through the versatile connection means frames and versatile connection means at any time in order to achieve predetermined audio video functions, such as a versatile active speaker functions and upgradeable karaoke system, predetermined performances, such as the lyrics and notes generation capabilities to convert a general audio video unit into a karaoke system, and optimal system utilization by embedding the identification codes in the data packets.

### BACKGROUND OF THE INVENTION

In the audio video industries, particularly in the karaoke industry, the technologies have been advancing in a fast pace so that an audio video device and/or karaoke device may become out-of date or even obsolete from time to time. For instance, the media players for the audio video industries and karaoke industry have been progressing from vinyl records to cassette tapes, and then from cassette tapes to compact disks (CD's), and then from CD's to video CD's (and/or CD graphics), and then from video CD's and CD graphics to DVD's. It has become predictable that the DVD's will be replaced with another format of improved data storage media and decoding methods at some time in the future. As long as the technologies keep progressing and mankind's curiosity and creativities keep active, it is imperatively obvious that this progressively technological trend will not cease. Under such circumstances, the consumers and users will be facing new and improved product types and product categories all the time. As a result, the users need to buy a new unit in order to have new technological features. Since the older unit is normally out of date, it is set aside or disposed. This is not only uneconomic but also not environment friendly.

Hence, it is the major concern of the present invention to provide the method and apparatus of a versatile audio video device that can have the device upgraded by the users as needed to keep in pace with the technologies without disposing the entire unit or set.

### OBJECTS AND ADVANTAGES OF THE INVENTION

Accordingly, the present invention is used to introduce a method and apparatus for a device configuration that can provide the users the option of partially upgrading the function of an audio video device or a portion of an audio video device, without making the bulk parts of the audio video device obsolete. With the present invention, the useable life of an audio video device is prolonged while, due to the nature of upgradeable functions, the consumers are more willing to invest in an audio video device at any time without the fear of having the purchased audio video unit be obsolete any time soon. With such confidence from the consumers, the economy activities in the society will be greatly enhanced without the side effects of creating much waste due to obsolete devices.

The advantages and primary object of the present invention are to provide a flexible and versatile audio video device by incorporating upgradeable features, particularly to provide an economic, long-lasting, interactive and environment-friendly audio video device to enhance not only the users' enjoyment but also overall economy activities.

### BRIEF DESCRIPTION OF THE DRAWINGS

FIG. 1 illustrates the detail configuration of a versatile audio video or karaoke system.

FIG. 2 illustrates the detail configuration of the versatile connection mechanism.

FIG. 3 illustrates the configuration of adding supporting equipment to the versatile audio video or karaoke system as shown in FIG. 1.

### DETAIL DESCRIPTION OF THE METHOD AND EMBODIMENT

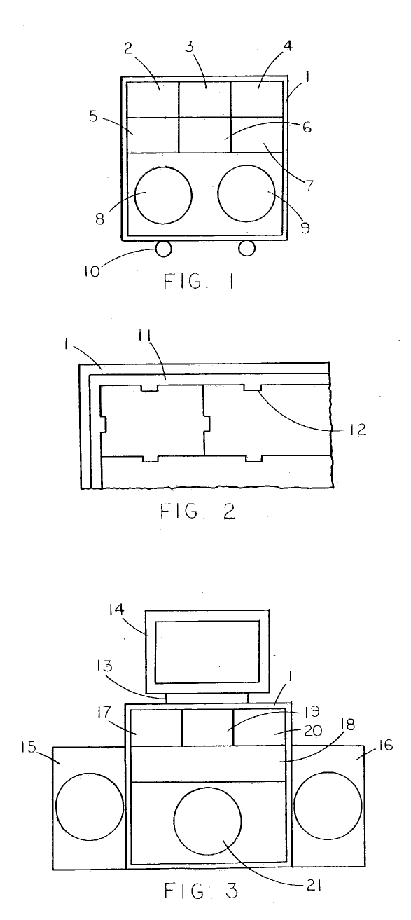

A method to achieve an upgradeable/versatile audio video or karaoke system is to have the audio video or karaoke system constructed with a versatile case that can allow any number or combination of audio video function and/or function units to be added to or removed from the versatile case at any time in order to achieve predetermined audio video functions and performances. A versatile and upgradeable audio video or karaoke system to implement the above method is illustrated in FIGS. 1 and 2 in which numeral 1 illustrates the audio video or karaoke system case, numerals 2 through 9 illustrates the audio video function units, numeral 10 illustrates the wheels for making the versatile and upgradeable audio video or karaoke system portable, numeral 11 illustrates the versatile connection means frame which may also be configured to be removable and upgradeable from the audio video or karaoke system case, and numeral 12 illustrates the versatile connection means. Once the versatile connection means frame, 11, is installed, all audio video function units can be placed to any appropriate locations through the versatile connection means, 12.

As a specifically illustration, the embodiment as indicated in FIG. 1 can be set up as an audio video system or a karaoke system in which numeral 2 illustrates a removable and upgradeable first diskette player, numeral 3 illustrates a removable and upgradeable display device such as a television display set, numeral 4 illustrates a removable and upgradeable second diskette player, numeral 5 illustrates a removable and upgradeable amplifier, numeral 6 illustrates a removable and upgradeable sound effect device, numeral 7 illustrates a removable and upgradeable audio video mixing device, numeral 8 illustrates the removable and upgradeable right channel speaker, numeral 9 illustrates the removable and upgradeable left channel speaker.

If an audio video system with home theater setup is desired, a television, 14, a TV stand, 13, a left channel large speaker, 15, and a right channel large speaker, 16, can be added to the audio video or karaoke system case, 1, as shown in FIG. 3. The audio video function units, 2-9, in FIG. 1 can be modified to be audio video function units, 17-21, in FIG. 3 in which numeral 17 illustrates a DVD player, numeral 18 illustrates removable rechargeable batteries, numeral 19 illustrates a sound effect device and home theater amplifier/receiver, numeral 20 illustrates a combo of mass storage units and digital processing devices, and numeral 21 illustrates a central speaker. If the audio video function units, 17-21, is combined into one unit and contains a power amplifier, a versatile active speaker can be achieved. In this case, numeral 1 indicates the speaker unit case, numerals 17-20 are combined to indicate the audio video unit embedded with a power amplifier and numeral 21 is a speaker unit, which can be removable or exchangeable. A versatile connection means frame as indicated by numeral 11 in FIG. 1 needs to be installed in the speaker unit case for the audio video unit embedded with a power amplifier to be able to be added or removed. This versatile active speaker can become a passive speaker, which does not contain a power amplifier and needs a power amplifier to provide power to convert the electrical signal into sound, by removing the power amplifier imbedded in the audio video function unit from the case, 1. The speaker users can always change or upgrade the power amplifier to fit their particular needs.

The combo of mass storage units and digital processing devices as indicated in numeral 20 can include a high capacity CD changer (such as a 200-CD changer, etc.) and/or a hard-disk storage device utilized as a recording device. General-purpose processors can also be included in the combo of mass storage units and digital processing devices, 20, to be used not only as control devices for the audio video functions but also, with built-in modifiable software capabilities, as general computing or processing units to be utilized as a separate computer, calculator or other uses.

Sound cards, integrated circuit devices with firmware, and/or PC boards with firmware can be inserted into or changed with the ones in the audio video function units, 2-9 in FIG. 1 or 17-21 in FIG. 3, through one or more than one sides of an audio video function unit as an even more practical way to enhance and/or vary the functions of the audio video function units. One particular desired feature to be incorporated into the audio video function units is to have a process imbedded in the form of hardware, firmware or software such that the lyrics or the notes of the content or data streams in the music or movies can be processed or decoded to be extracted and utilized thereafter. One of the way to utilize the above feature is to have the lyrics or the notes displayed on a display device, such as a television or a monitor, on the fly so that the person who is using the audio video system may sing along the lyrics and/or the notes or utilize any combination and processed forms of the lyrics and the notes. As a result, any music or movies recorded in any form of media (such as tape, CD, DVD, etc.) can be analyzed by the above hardware, firmware and/or software and have the on-going lyrics, notes or some other vital information be decoded and extracted so that these lyrics or notes can be displayed on a monitor for the users or singers to follow or use. The processed forms may include harmonics, key, reverb, echo, or any other sound process results. With the above features, any audio video unit can be converted to be a karaoke device.

In order to standardize the communications among the audio video function units, a standard universal bus configuration can be included in the versatile audio video or karaoke system. The standard universal bus can include a data bus, a control bus, data input/output control means that communicate with the data bus and/or audio video function units. The data bus and the control bus can be either an optical signal bus or an electrical signal bus. Each audio video function embedded with some decoding device acts as a network terminal to receive and/or send serial data packets as commanded by the prevailing data packet at any time. An optimal serial data packet configured with the identification code (ID Code) is the leading component of the serial data packet followed by a data number indicator, N, and then followed by a number N of data set components (D1, D2, . . . , DN). Normally, the ID Code includes the identification number of an audio video function unit and the last data set, DN, is used to indicate the identification number of the audio video function unit that is to send the next serial data packet to the data bus. The control bus is used to sequence and acknowledge the timing of sending one component of the serial data packet from the source audio video function unit to the data bus and the timing of directing the component of the serial data packet from the data bus to the destination audio video function units. At any time, only the data input/output control means of the source audio video function unit or the destination audio video function units can be enabled to allow the component of the serial data packet to flow through or to be decoded. In the mean time, a security code can be added to the ID code so that only the designated audio video function unit can be authorized to utilize the component of the serial data packet as a security measure.

### SUMMARY, RAMIFICATION, AND SCOPE

Accordingly, it can be seen that the method for a versatile audio video or karaoke system can greatly enhance the flexibilities of the users of an audio video or karaoke system as to what audio video configurations or functions to be used at ant time and when to use those configurations and functions. Furthermore, the versatile audio video or karaoke system provides the versatility of including the general computing and processing units to perform any computer or calculator tasks with the support of the universal bus among network terminals.

Furthermore, the present invention has the additional advantages in that.

It enables the audio video or karaoke users to upgrade their equipment to catch up with any new technologies just by upgrading a portion of the equipment, instead of getting new equipment like a traditional audio video device;

It enhances the easiness and convenience of maintenance and repairing since only one or a few audio video function units, instead of the whole equipment, need to be removed to be repaired.

Although the above detail description contains many specifications, these should not be construed as limiting the scope of the invention but as merely providing illustrations of some of the presently preferred embodiments of this invention. For example, the audio video or karaoke system case is illustrated with a rectangular box purely for illustration purpose, while other alternative designs are feasible and inclusive in the present invention; the configuration of the versatile connection means frame and the versatile connection means are placed at certain locations and/or with certain structure merely for illustration purpose, while other placement and structure designs are feasible and inclusive in the present invention. Likewise, the design of the audio video function units and other details are purely for illustration purposes. Thus the scope of the invention should be determined by the appended claims and their legal equivalents, rather than by the examples given.

1. A method of enabling an audio video apparatus to have predetermined functions changeable by configuring each function or any combination of functions in a function unit such that a predetermined number of said function units latching into said audio video apparatus through predetermined connection means at predetermined locations communicate to each other to achieve predetermined audio video functions thereby any predetermined audio video function can be incorporated into said audio video apparatus with predetermined function units.

2. A method of enabling an audio video apparatus to be upgradeable as set forth in claim 1 wherein said function units comprise one or more than one firmware processing means.

3. A method of enabling an audio video apparatus to be upgradeable as set forth in claim 1 wherein said function units comprise one or more than one software processing means.

4. A method of directing data among audio video function units by transmitting data packets including identification code along data transmission means connecting said audio video function units imbedded with decoding means thereby said data packets transmitted to said audio video function units gets decoded by said audio video function units and only those of said audio video function units with identification code matching said identification code imbedded in said data packets are allowed to utilize said data packets.

5. A method of converting an audio video function unit into a karaoke unit by embedding a conversion means in said audio video function unit thereby said conversion means process data streams in said audio video function and extract lyrics and/or notes from said data streams whereby said lyrics and/or notes can be directed to a display means to be utilized therein.

6. A method of converting an audio video function unit into a karaoke unit as set forth in claim 5 wherein said audio video function unit is a CD player.

7. A versatile speaker to be able to be utilized as a passive speaker or an active speaker comprising a speaker containing means, an amplification means, a sound reinforcement means and a connection means thereby, if said versatile speaker does not include said sound reinforcement means, said amplification means can be added to said connection means to have said versatile speaker include said sound reinforcement means and, if said versatile speaker includes said sound reinforcement means, said amplification means can be removed from said connection means to have said versatile speaker not include said sound reinforcement means.

8. A versatile speaker to be able to be utilized as a passive speaker or an active speaker as set forth in claim 7 wherein said amplification means is a digital power amplifier.
